(19) United States
(12) Patent Application Publication
(10) Pub. No.: US 2020/0126236 A1
(43) Pub. Date: Apr. 23, 2020

(54) Systems and Methods for Image Segmentation using IOU Loss Functions

(71) Applicant: The Board of Trustees of the Leland Stanford Junior University, Stanford, CA (US)

(72) Inventors: Blaine Burton Rister, Stanford, CA (US); Darvin Yi, Menlo Park, CA (US); Daniel L. Rubin, Stanford, CA (US)

(73) Assignee: The Board of Trustees of the Leland Stanford Junior University, Stanford, CA (US)

(21) Appl. No.: 16/660,614

(22) Filed: Oct. 22, 2019

Related U.S. Application Data
(60) Provisional application No. 62/749,053, filed on Oct. 22, 2018.

(51) Int. Cl. G06T 7/11; G06K 9/62; G06T 7/00; G06T 7/30; G06K 9/00; G06K 9/20

(52) U.S. Cl. CPC G06T 7/11; G06T 2207/20056; G06K 9/6257; G06T 7/0012; G06T 7/30; G06K 9/6292; G06K 9/00201; G06K 9/2054; G06K 2209/051; G06T 2207/20084; G06T 2207/20081; G06T 2207/10081; G06T 2207/10104; G06T 2207/30096; G06K 9/6267

(57) ABSTRACT

Systems and methods for image segmentation in accordance with embodiments of the invention are illustrated. One embodiment includes a method for segmenting medical images, including obtaining a medical image of a patient, the medical image originating from a medical imaging device, providing the medical image of the patient to a fully convolutional neural network (FCN), where the FCN comprises a loss layer, and where the loss layer utilizes the CE-IOU loss function, segmenting the medical image such that at least one region of the medical image is classified as a particular biological structure, and providing the medical image via a display device.

### CROSS-REFERENCE TO RELATED APPLICATIONS

The current application claims the benefit of and priority under 35 U.S.C. § 119(e) to U.S. Provisional Patent Application No. 62/749,053 entitled “Automatic Organ Segmentation and Lesion Detection” filed Oct. 22, 2018 the disclosure of which is hereby incorporated by reference in its entirety for all purposes.

### STATEMENT OF FEDERALLY SPONSORED RESEARCH

This invention was made with Government support under contract CA190214 awarded by the National Institutes of Health. The Government has certain rights in the invention.

### FIELD OF THE INVENTION

The present invention generally relates to image segmentation, namely segmentation of organs in radiology images.

### BACKGROUND

Radiology is the medical specialty that uses medical imaging to diagnose and treat medical conditions within the body. There are many medical imaging modalities that each have advantages and disadvantages. Example modalities include, but are not limited to, radiography, ultrasound, computed tomography (CT), positron emission tomography (PET), magnetic resonance imaging (MRI), and many others. In many situations, different modalities and/or different applications of a modality are better at observing particular types of tissue, e.g. bone, soft tissue, organs, etc. Medical imaging systems produce image data that are used by radiologists to make diagnoses.

Neural networks are a class of machine learning model where layers of sets of nodes are connected to form the network. Neural networks are trained by providing a set of ground truth training data as inputs which can be used to calibrate weight values associated with nodes the network. Weights are utilized to modify the input signal to produce the output signal. A specific type of neural network is the convolutional neural network (CNN) that utilize one or more layers of convolution nodes. Convolutional neural networks often employ a loss function which specifies how training penalizes the deviation between a predicted output and a true label. Loss functions are often tailored to a particular task. Fully convolutional neural networks (FCNs) are CNNs where all learnable layers are convolutional.

### SUMMARY OF THE INVENTION

Systems and methods for image segmentation in accordance with embodiments of the invention are illustrated. One embodiment includes a method for segmenting medical images, including obtaining a medical image of a patient, the medical image originating from a medical imaging device, providing the medical image of the patient to a fully convolutional neural network (FCN), where the FCN comprises a loss layer, and where the loss layer utilizes the CE-IOU loss function, segmenting the medical image such that at least one region of the medical image is classified as a particular biological structure, and providing the medical image via a display device.

In another embodiment, the CE-IOU loss function is defined as

$${L}_{CE \text{-} IOU} ( p , y ) = \frac{1 + \frac{1}{\vert k \text{:} {y}_{k} = 1 \vert} {\sum }_{\vert k : {y}_{k} = 1 \vert}^{n} {𝓁}_{CE} ( {p}_{k} , {y}_{k} )}{1 + \frac{1}{\vert k \text{:} {y}_{k} \neq 1 \vert} {\sum }_{\vert k : {y}_{k} \neq 1 \vert}^{n} {𝓁}_{CE} ( {p}_{k} , {y}_{k} )}$$

In a further embodiment, the CE-IOU loss function is capable of distinguish multiple tasks, and is defined as

$${ℒ}_{MC} ( p , y ) = \frac{1}{m} {\sum }_{c = 1}^{m} \frac{1 + \frac{1}{\vert k \text{:} {y}_{k} = 1 \vert} {\sum }_{\vert k : {y}_{k} = 1 \vert}^{n} {𝓁}_{c} ( {p}_{k} , {y}_{k} )}{1 + \frac{1}{\vert k \text{:} {y}_{k} \neq 1 \vert} {\sum }_{\vert k : {y}_{k} \neq 1 \vert}^{n} {𝓁}_{c} ( {p}_{k} , {y}_{k} )}$$

In still another embodiment, the FCN characterized by having been trained using training data, where the training data was augmented using a graphics processing unit (GPU) accelerated augmentation process including obtaining at least one base annotated medical image, computing an affine coordinate map for the at least one base annotated medical image, sampling the at least one base annotated medical image at at least one coordinate in the affine coordinate map, applying at least one photometric transformation to generate an intensity value, and outputting the intensity value to an augmented annotated medical image.

In a still further embodiment, the at least one photometric transformation is selected from the group consisting of: affine warping, occlusion, noise addition, and intensity windowing.

In yet another embodiment, the medical image of the patient comprises a CT image of the patient; and the method further includes detecting lesions within segmented organs by obtaining a PET image of the patient, where the CT image and the PET image were obtained via a dual CT-PET scanner registering the at least one classified region of the CT image to the PET image, computing organ labels in the PET image, searching for lesions in the PET image, wherein the search utilizes ratios of convolutions, identifying lesion candidates by detecting 3D local maxima in a 4D scale-space tensor produced by the search, and providing the lesion candidates via the display device.

In a yet further embodiment, searching for lesions in the PET image is accelerated using fast Fourier transforms.

In another additional embodiment, the 4D scale-space tensor is defined by

L(x, σ) 32 ∇G_{σ}(x)×ƒ|ₛ(x).

In a further additional embodiment, the display device is a smartphone.

In another embodiment again, the medical image is a 3D volumetric image.

In a further embodiment again, an image segmenter, including at least one processor, and a memory in communication with the at least one processor, the memory containing an image segmentation application, where the image segmentation application directs the processor to obtain a medical image of a patient, the medical image originating from a medical imaging device, provide the medical image of the patient to a fully convolutional neural network (FCN), where the FCN comprises a loss layer, and where the loss layer utilizes the CE-IOU loss function, segment the medical image such that at least one region of the medical image is classified as a particular biological structure, and provide the medical image via a display device.

In still yet another embodiment, the CE-IOU loss function is defined as

$${L}_{CE \text{-} IOU} ( p , y ) = \frac{1 + \frac{1}{\vert k \text{:} {y}_{k} = 1 \vert} {\sum }_{\vert k : {y}_{k} = 1 \vert}^{n} {𝓁}_{CE} ( {p}_{k} , {y}_{k} )}{1 + \frac{1}{\vert k \text{:} {y}_{k} \neq 1 \vert} {\sum }_{\vert k : {y}_{k} \neq 1 \vert}^{n} {𝓁}_{CE} ( {p}_{k} , {y}_{k} )}$$

In a still yet further embodiment, the CE-IOU loss function is capable of distinguish multiple tasks, and is defined as

$${ℒ}_{MC} ( p , y ) = \frac{1}{m} {\sum }_{c = 1}^{m} \frac{1 + \frac{1}{\vert k \text{:} {y}_{k} = 1 \vert} {\sum }_{\vert k : {y}_{k} = 1 \vert}^{n} {𝓁}_{c} ( {p}_{k} , {y}_{k} )}{1 + \frac{1}{\vert k \text{:} {y}_{k} \neq 1 \vert} {\sum }_{\vert k : {y}_{k} \neq 1 \vert}^{n} {𝓁}_{c} ( {p}_{k} , {y}_{k} )}$$

In still another additional embodiment, the FCN is characterizable by having been trained using training data, where the training data was augmented using a graphics processing unit (GPU) accelerated augmentation process including obtaining at least one base annotated medical image, computing an affine coordinate map for the at least one base annotated medical image, sampling the at least one base annotated medical image at at least one coordinate in the affine coordinate map, applying at least one photometric transformation to generate an intensity value, and outputting the intensity value to an augmented annotated medical image.

In a still further additional embodiment, the at least one photometric transformation is selected from the group consisting of: affine warping, occlusion, noise addition, and intensity windowing.

In still another embodiment again, the medical image of the patient includes a CT image of the patient; and the image segmenting application further directs the processor to detect lesions within segmented organs by obtaining a PET image of the patient, where the CT image and the PET image were obtained via a dual CT-PET scanner, registering the at least one classified region of the CT image to the PET image, computing organ labels in the PET image, searching for lesions in the PET image, wherein the search utilizes ratios of convolutions, identifying lesion candidates by detecting 3D local maxima in a 4D scale-space tensor produced by the search, and providing the lesion candidates via the display device.

In a still further embodiment again, searching for lesions in the PET image is accelerated using fast Fourier transforms.

In yet another additional embodiment, the 4D scale-space tensor is defined by

L(x, σ)=∇G_{σ}(x)×ƒ|ₛ(x).

In a yet further additional embodiment, the display device is a smartphone.

In yet another embodiment again, the medical image is a 3D volumetric image.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a conceptual system diagram for an image segmentation system in accordance with an embodiment of the invention.

FIG. 2 is a high-level block diagram for an image segmenter in accordance with an embodiment of the invention.

FIG. 3 is a high level flow chart illustrating a process for segmenting images in accordance with an embodiment of the invention.

FIG. 4 illustrates a segmented image of a torso where the lungs have been highlighted using an image segmenter in accordance with an embodiment of the invention.

FIG. 5 illustrates a segmented image of a torso where the bones have been highlighted using an image segmenter in accordance with an embodiment of the invention.

FIG. 6 is a flow chart illustrating a process for augmenting training data in accordance with an embodiment of the invention.

FIG. 7 is a diagram illustrating a memory transfer pipeline in accordance with an embodiment of the invention.

FIG. 8 is a table illustrating layers in an FCN in accordance with an embodiment of the invention.

FIG. 9 is a chart illustrating a performance comparison between an IOU loss function and a CE-IOU loss function in accordance with an embodiment of the invention.

FIG. 10 is a flow chart illustrating a process for identifying lesion candidates in accordance with an embodiment of the invention.

FIG. 11 illustrates identified cancer lesions in accordance with an embodiment of the invention.

### DETAILED DESCRIPTION

Turning now to the drawings, systems and methods for image segmentation are disclosed. The ability to distinguish pixels that represent a particular organ from background pixels in a medical image is an important and highly desirable feature for any medical imaging system. The classified pixels can be used to quickly calculate information regarding the organ, provide a focused view for a medical practitioner, provide clean input data to digital processing pipelines, as well as many other uses. In the past, image segmentation was performed by hand, using basic edge detection filters, and other mathematical methods. Recently, machine learning systems have become a useful tool for organ segmentation.

In general, approaches to organ segmentation can be divided into two categories: semi-automatic and fully-automatic. Semi-automatic approaches use a user-generated starting shape, which grows or shrinks into the organ of interest. These approaches typically take into account intensity distributions, sharp edges and even the shape of the target organ. Their success depends greatly on the initialization, as well as the organ of interest. They are highly sensitive to changes in imaging conditions, such as the use of intravenous (IV) contrast agents. These methods are especially well-suited to organs with distinctive appearance, such as the liver. Besides the need for user interaction, a main drawback to these approaches is a tendency to “leak” out of the target organ, especially for soft tissues with low intensity contrast.

In contrast, fully-automatic methods, require no user input, as they directly detect the object of interest in addition to delineating its boundaries. Detection techniques can be divided into two main areas, pattern recognition and atlas-based methods. Generally, pattern recognition systems utilize neural networks to classify pixels, whereas atlas-based methods work by warping, or registering an image to an atlas, which is a similar image in which all the organs have been labeled. While atlas-based methods can achieve high accuracy, inter-patient registration is computationally expensive and extremely sensitive to changes in imaging conditions. For example, an atlas-based method would have difficulty accounting for the absence of a kidney. Consequently, atlas-based methods are more suited to stationary objects of consistent size and shape, such as the brain, and therefore have not found the same level of success in whole-body imaging scenarios.

As there are many situations in which a large portion or all of a patient's body is imaged, it is desirable to have an image segmentation methodology that can automatically detect any arbitrary objects or set of objects. Fully convolutional neural networks (FCNs) have become a popular class of neural networks to tackle the challenge of organ segmentation. However, many FCN-based fully-automatic methods are limited to identifying a specific organ or body region around which they expect the image will be cropped. Further, FCNs present unique challenges, namely the need for large scale parallel computation and the preparation of sufficiently large and accurate training data sets. Due to the present lack of availability of sufficient training data sets in the medical space, and the inherent computational issues in volumetric image processing, conventional methodologies suffer from a variety of issues including, but not limited to, poor training, deleteriously long run times given the need for immediate diagnoses, and high cost associated with generating training data and maintaining sufficient computing power. Further, as complex FCNs presently consume a prohibitive amount of high-bandwidth memory when applied to 3D volumetric images, conventional approaches generally tend apply 2D models to 3D data.

Systems and methods described herein can ameliorate many of these problems. Image segmentation processes described herein utilize simple models that naturally apply to a wide variety of objects and can be operated in a fully-automated fashion. Further, the models described herein are memory-efficient and capable of processing large sections of the body at once. In some embodiments, the entire body can be processed at once. In various embodiments, the models utilized are computationally efficient as well as memory efficient which can be deployed on a wide variety of computing platforms.

Additionally, data augmentation methods are described herein which efficiently augment 3D images using graphics processing unit (GPU) texture sampling and random noise generation. An automatic training label generation process is described which can be accelerated using 3D Fourier transforms and requires no user inputs. The models described herein can be trained using augmented training data. Moreover, a joint cross-entropy IOU (CE-IOU) loss function is described which can be used in generating the models described herein. Image segmentation systems are discussed below.

### Image Segmentation Systems

Image segmentation systems are computing systems capable of taking in medical images and segmenting them. In numerous embodiments, image segmentation systems are made of multiple computing devices connected via a network in a distributed system. In many embodiments, image segmentation systems include medical imaging systems that can scan patients and produce image data describing a medical image of the patient. In a variety of embodiments, image segmentation systems can segment images produced by any arbitrary medical imaging modality, however some image segmentation systems are specialized for a particular imaging modality.

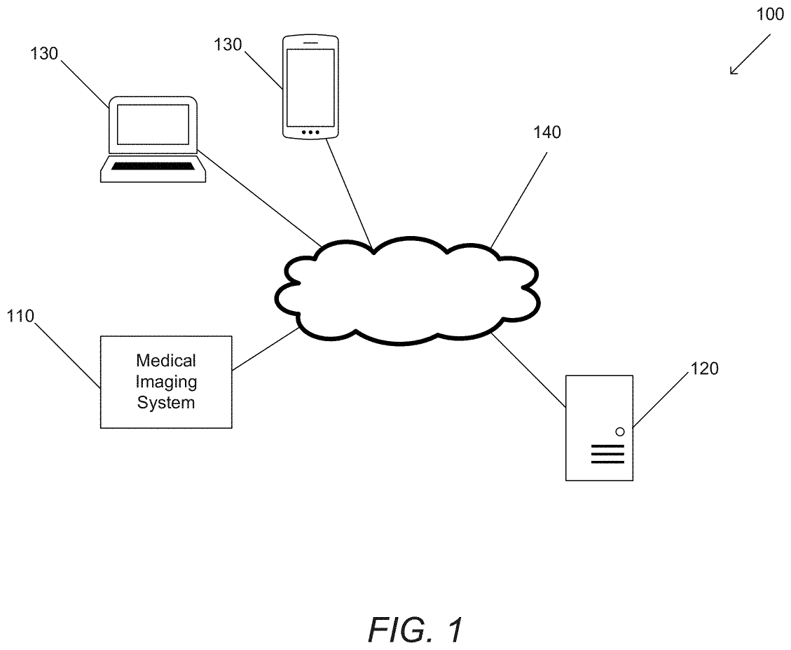

Turning now to FIG. 1, an image segmentation system in accordance with an embodiment of the invention is illustrated. System 100 includes a medical imaging system 110. Medical imaging systems can be any number of systems including, but not limited to, CT scanners, PET scanners, MRI scanners, digital x-ray radiography machines, and/or any other imaging system as appropriate to the requirement of a given application of an embodiment of the invention. System 100 further includes an image segmenter 120. In many embodiments, image segmenters are computing devices capable of running image segmenting applications. In various embodiments, image segmenters are computer servers. In numerous embodiments, image segmenters are personal computers. However, image segmenters can be any computing device as appropriate to the requirements of specific applications of embodiments of the invention.

System 100 also includes display devices 130. Display devices are devices capable of displaying segmented images. Display devices can be any number of different devices including, but not limited to, monitors, televisions, smart phones, tablet computers, personal computers, and/or any other device capable of displaying image data. In various embodiments, display devices and image segmenters are implemented on the same hardware platform. Medical imaging system 110, image segmenter 120, and display devices 130 are connected via a network 140. Network 140 can be any number of different types of wired and/or wireless networks. In many embodiments, the network is made up of multiple different networks that are connected.

While a specific network is illustrated with respect to FIG. 1, any number of different system architectures can be used such as, but not limited to, utilizing different modalities of medical imaging systems, different numbers of medical imaging systems, stand-alone image segmenters, different numbers of display devices, and/or any other architecture as appropriate to the requirements of specific applications of embodiments of the invention. Image segmenters in particular are discussed in further detail below.

### Image Segmenters

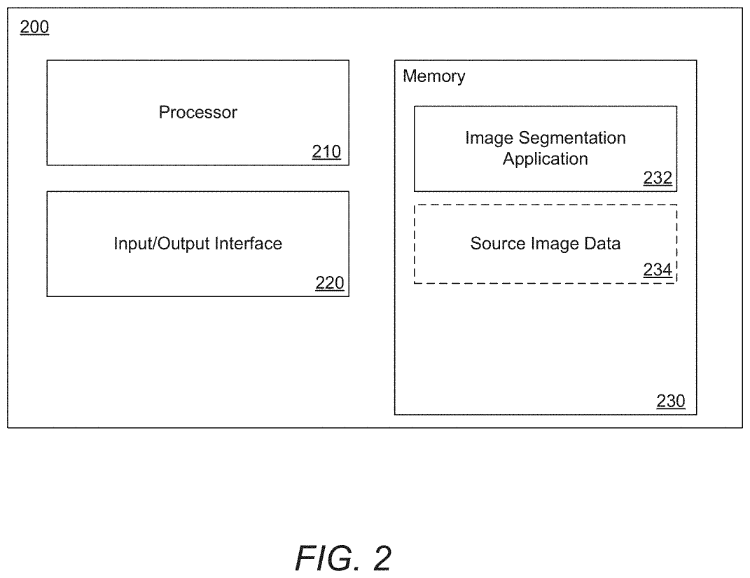

As noted above, image segmenters are computing devices capable of segmenting medical images. In some embodiments, image segmenters are used to generate training data for training machine learning models. Turning now to FIG. 2, an image segmenter architecture in accordance with an embodiment of the invention.

Image segmenter 200 includes a processor 210. Processors can be any type of logic processing circuitry such as, but not limited to, a central processing unit (CPU), a graphics processing unit (GPU), a field-programmable gate-array (FPGA), an application specific integrated circuit (ASIC), and/or any other logic circuitry as appropriate to the requirements of specific applications of embodiments of the invention. In many embodiments, the processor is implemented using multiple diffing processor circuits such as, but not limited to, one or more CPUs along with one or more GPUs.

Image segmenter 200 further includes an input/output (I/O) interface 220. I/O interfaces can enable communication between the image segmenter and other components of image segmenting systems such as, but not limited to, display devices and medical imaging systems. In various embodiments the I/O interface enables a connection to a network.

Image segmenter 200 further includes a memory 230. Memory can be volatile memory, non-volatile memory, or any combination thereof. The memory 230 stores an image segmentation application 232. Image segmentation applications can configure processors to perform various processes. In numerous embodiments, the memory 230 includes a source image data 234. The source image data can be generated and/or obtained from a medical imaging system and the described image can be segmented in accordance with the image segmentation application.

While a specific image segmenter is discussed above with respect to FIG. 2, any number of different image segmenter architectures can be used as appropriate to the requirements of specific applications of embodiments of the invention. As noted, image segmenters can segment medical images. Image segmentation processes are discussed below.

### Image Segmentation Processes

Image segmentation processes can be utilized to segment a medical image to make selectable any arbitrary class of tissue or structure. In many embodiments, image segmentation processes are performed using a FCN. However, FCNs must be trained prior to use. In various embodiments, image segmenters can further train FCNs, although in many embodiments, image segmenters merely obtain previously trained FCNs. FCNs described herein utilize specific types of loss functions in order to perform efficiently on any arbitrarily sized medical imaging data. The training process for an FCN described herein can be further made more efficient by using augmented training data sets.

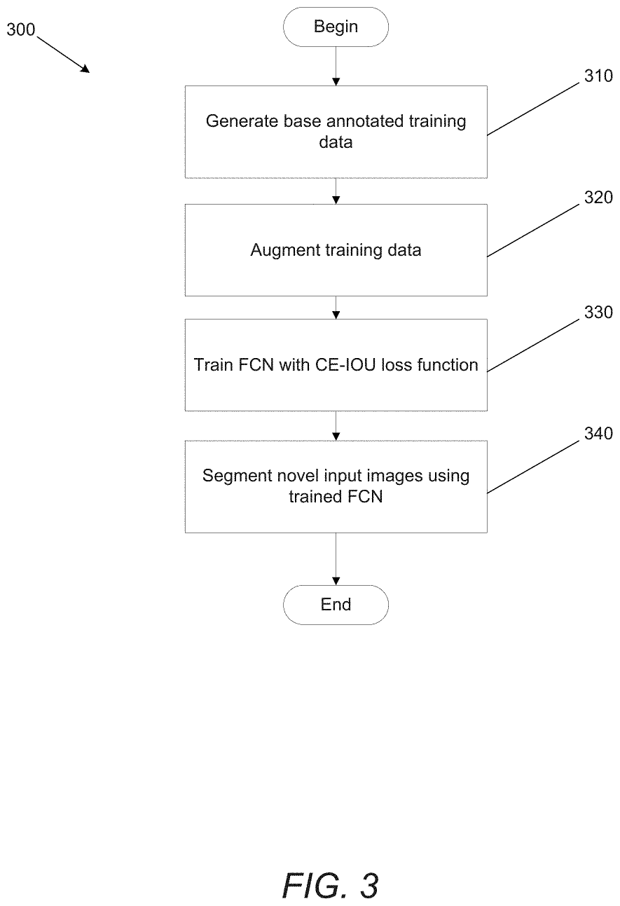

Turning now to FIG. 3, a process for segmenting images using FCNs in accordance with an embodiment of the invention is illustrated. Process 300 includes generating (310) base annotated training data. In numerous embodiments, generating base annotated training data involves segmenting training images such that they are labeled with ground truth segments. The training data can then be augmented (320) and used to train (330) an FCN with a CE-IOU loss function. The trained model can be used to segment (340) novel input medical images which can be displayed (350) via display device. As each of the above steps has various complexities, they are each discussed in respective sections below.

### Training Label Generation

In the image processing context, training data sets are sets of images where each image is annotated with labels that accurately and truthfully reflect the classification of the particular image. When generating training data, it is important to have a high degree of accuracy in the annotations, as the learned “truth” for any model trained using the training data will be based on the ground truth of the training data. In order to automatically and accurately label training data, methods described herein can use Fourier transforms to accelerate binary image morphology processes to identify regions of images and apply labels.

The basic operations of morphology are “erosion” and “dilation”, defined relative to a given shape called a “structuring element.” The structuring element is another binary image defining the neighbor connectivity of the image. For example, a two-dimensional cross defines a 4-connected neighborhood. A binary image consists of pixels (or voxels in the 3D space) that are either black or white. Binary erosion is a process where every pixel neighbor to a black pixel is set to black. Dilation is the same process, except for white pixels. Simply, erosion makes objects smaller, while dilatation makes them lager. From these operations more complex ones are derived. For example, closing is defined as dilation followed by erosion, which fills holes and bridges gaps between objects. Similarly, opening is just erosion followed by dilation, which removes small objects and rounds off the edges of large ones.

Let ƒ: [symbol] ⁿ→ [symbol] ² denote a binary image, and k: [symbol] ⁿ→ [symbol] ² denote the structuring element. Then we can write dilation as:

$$D ( f , k ) ( x ) = \{ \begin{matrix}1 , & ( f * k ) ( x ) > 0 \\ 0 , & \text{otherwise}\end{matrix} .$$

That is, first ƒ is convolved with k, treating the two as real-valued functions on [symbol] ⁿ. Then, convert back to a binary image by setting zero-valued pixels to black and all others to white. Erosion is computed similarly: if ƒ̅ is the binary compliment of ƒ, then erosion is E(ƒ,k)(x)=D̅(̅ƒ̅,̅k̅)̅.

Written this way, all of the basic operations in the n-dimensional binary morphology reduce to a mixture of complements and convolutions, the latter of which can be computed by fast Fourier transforms (FFTs), due to the identify [symbol] =\hat{ƒ} ·\hat{k}, where \hat{ƒ} denotes the Fourier transform of ƒ. By leveraging FFTs, training labels can be quickly applied to training images by segmenting them using morphological operations. Specific sets of operations can be used for specific sets of tissues to be segmented, but by utilizing the above morphological operations to generate a set of convolutions, segmentation can be accelerated using Fourier transforms.

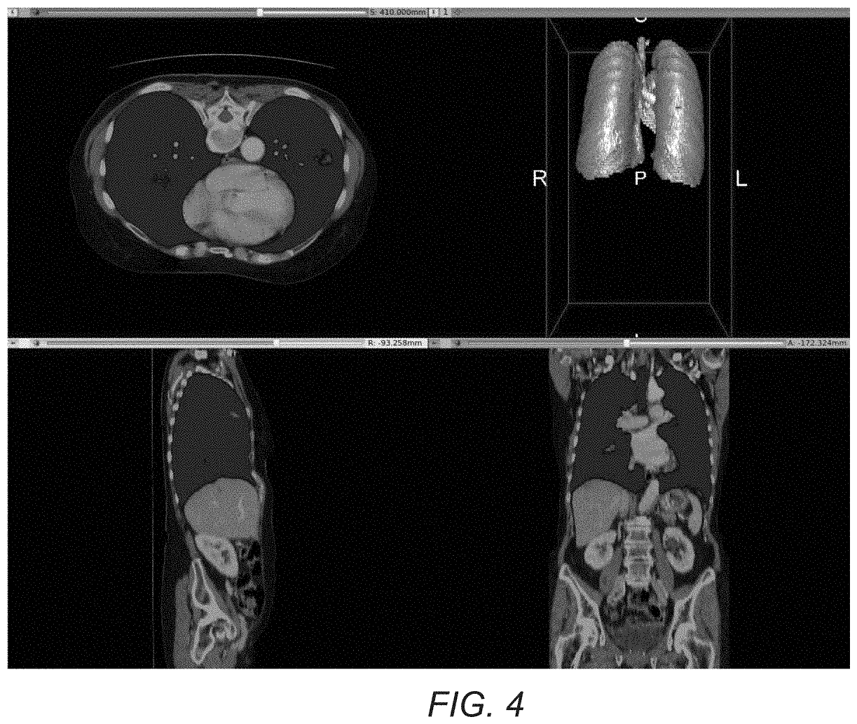

For example, in the case of the lungs, as the two largest pockets of air in the body, they can be easily identified using morphological operations. First, air pockets can be extracted from a 3D volumetric image of a body by removing all voxels greater than −150 Hounsfield units (HU). The resulting mask is called the thresholded image. Then, small air pockets can be removed by morphologically eroding the image using a spherical structuring element with a diameter of 1 cm. Next, any air pockets which are connected to the boundary of any axial slice in the image can be removed. This removes air outside of the body, while preserving the lungs. From the remaining air pockets, the two largest connected components can be assumed to be the lungs. Finally, the effect of erosion can be undone by taking the components of the thresholded image which are connected to the two detected lungs. The result of this process is illustrated in accordance with an embodiment of the invention in FIG. 4. Similar processes can be conducted using characteristics of any arbitrary organ or tissue.

In the case of bone, segmentation proceeds similarly using a combination of thresholding, morphology operations, and selection of the largest connected components. Two intensity thresholds, τ1=0 HU and τ2=200 HU are defined. These were selected so that almost all bone tissue is greater than τ1, while the hard exterior of each bone is usually greater than τ2. However, these numbers can be modified based on the particular data and tissue. Exteriors of all the bones in the image can be selected by thresholding the image by τ2. This step often includes some unwanted tissues, such as the aorta, kidneys and intestines, especially in images produced by contrast-enhanced CTs. To remove these unwanted tissues, only the largest connected component is selected, which should be the skeleton. Next gaps in the exteriors of the bones are filled by morphological closing, using a spherical structuring element with a diameter of 2.5 cm. This step can have the unwanted side effect of filling gaps between bones as well, so the threshold τ1 can be applied to remove most of this unwanted tissue.

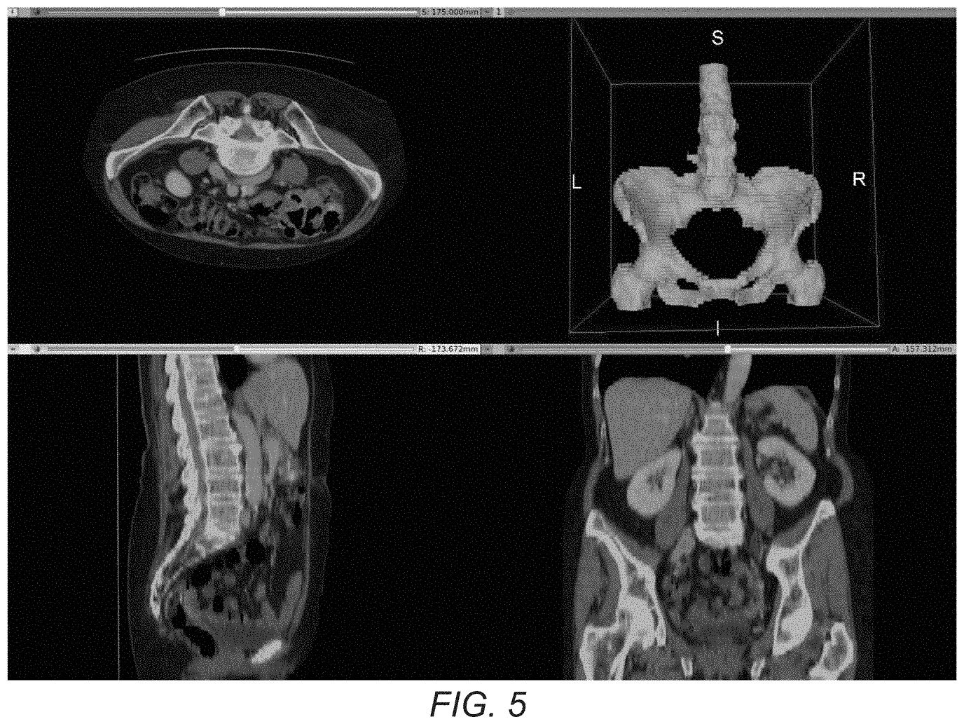

At this stage, there could be holes in the center of large bones, such as the pelvis and femurs. When the imaged patient is reclined on the exam table during scanning, large bones almost always lie parallel to the z-axis of the image. Accordingly, each xy-plane (axial slice) in the image can be processed to fill in any holes which are not connected to the boundaries. The result of this process in accordance with an embodiment of the invention is illustrated in FIG. 5.

As noted, in general, any arbitrary tissue can be segmented using morphological techniques, and Fourier transforms can be used to accelerate said segmentation. However, training data need not be specifically segmented using the above techniques. Indeed, any arbitrary base training data set can be augmented and used to train FCNs in accordance with the requirements of specific applications of embodiments of the invention. Processes for augmenting training data are discussed in further detail below.

### Augmenting Training Data

Neural networks can be viewed as blank slates on which a wide variety of classifiers can be inscribed. In this analogy, it is the training data that dictates the inscription. Advances in neural network training have recently led to the concept of data augmentation, whereby transforms are applied to a base set of training data in order to generate additional training data that represent scenarios outside the scope of the base training data set. Because the labels for images in the base training data set are known, the same labels can be inherited by their transformed analogs.

Augmentation of training data can be theoretically justified. Consider a binary segmentation scenario where x ϵ [symbol] ⁿ denotes a training input and y ϵ [symbol] ₂ ⁿ denotes binary training labels. That is, each image voxel xₖ ϵ [symbol] is associated with the class label yₖ ϵ {0,1}. Let ƒ (x, y) denote the data loss function, so training seeks to minimize the expected loss [symbol] _{x,y}ƒ(x,y). Now, say the data is augmented according to some parameters θ ϵ [symbol] ^{m}, and transformation function T(x, θ): [symbol] ⁿ× [symbol] ^{m}→ [symbol] ⁿ, and let ƒ(x, y, θ)=ƒ(T(x, θ),T(y, θ)). Since θ independent of x,y training seeks to minimize

[symbol]

_{x,y,θ}ƒ(x,y,θ)= [symbol] _{θ} [symbol] _{x,y}ƒ(x,y,θ)= [symbol] _{x,y} [symbol] _{θ}ƒ(x,y,θ).

Put simply, averaging over an augmented dataset is equivalent to augmenting the average datum, a consequence of Fubini's theorem. Viewed another way, let \tilde{x}=T(x,θ) and \tilde{y}=T(y,θ). Then training on augmented data is equivalent to training on the marginal distribution p(\tilde{x},\tilde{y})= [symbol] p(\tilde{x},\tilde{y},θ)dθ. This expands the data distribution beyond what was initially collected, ensuring that it exhibits the desired invariance.

Conventional data augmentation methods a varied and include, but are not limited to, affine warping, intensity windowing, additive noise, and occlusion. However, these operations tend to be expensive to compute over large 3D volumes such as those generated by many medical imaging modalities. As a particular example, affine warping generally requires random access to a large buffer of image data, with little reuse, which is inefficient for the cache-heavy memory hierarchy of CPUs. A typical CT scan consists of hundreds of 512×512 slices of 12-bit data. When arranged into a 3D volume, a CT scan is hundreds of times larger than a typical low-resolution photograph used in conventional computer vision applications.

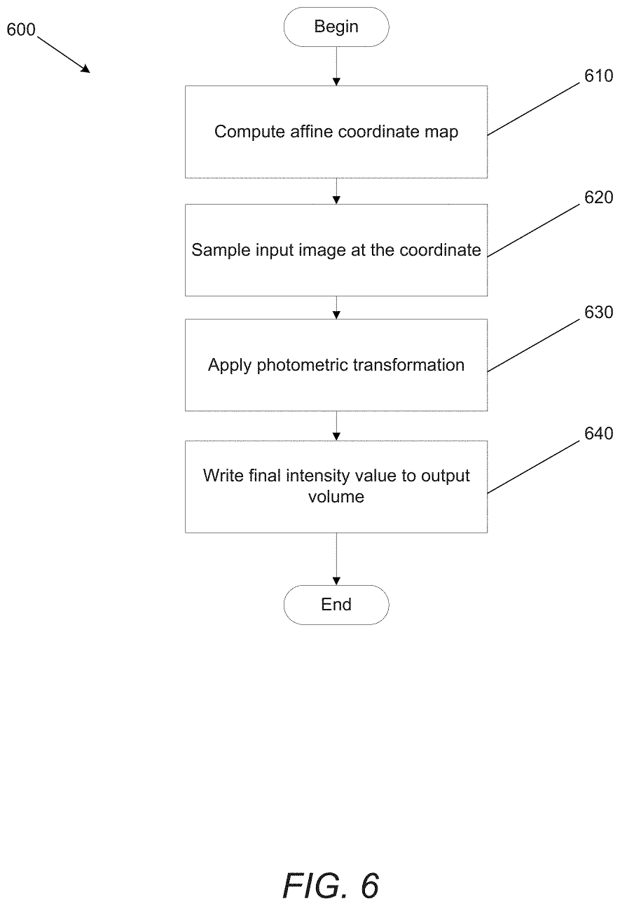

In order to more efficiently apply affine warping, GPU texture memory can be specifically leveraged. GPU texture memory tends to be optimized for parallel access to 2D or 3D images, and includes special hardware for handing out-of-bounds coordinates and interpolation between neighboring pixels. GPU architecture is also a ripe target for performing photometric operations such as noise generation, windowing, and cropping efficiently and in parallel. Below, methods for efficiently implementing these operations are discussed. In numerous embodiments, since these operations involve little reuse of data, each output pixel is drawn by its own CUDA thread. Turning now to FIG. 6, a high level method for generating an augmented image in accordance with an embodiment of the invention is illustrated. For each thread, process 600 includes computing (610) the affine coordinate map, sampling (620) the input image at that coordinate, applying (630) the photometric transformations, and then writing (640) the final intensity value to the output volume. In this way, each output requires only a single access to texture memory.

### Affine Warping

In order to efficiently implement affine warping leveraging GPU texture memory, sampling coordinates are computed as x′=Ax+b, where x, b ϵ [symbol] ³ and A ϵ [symbol] ^{3×3}. The matrix A can be generated by composing a variety of geometric transformations drawn uniformly from user-specified ranges. These include, but are not limited to, arbitrary 3D rotation, scaling, shearing, reflection, generic affine warping, and/or any other transformation as appropriate to the requirements of specific applications of embodiments of the invention. A random displacement d ϵ [symbol] ³ can be drawn from a uniform distribution according to user-specified ranges. Taking c ϵ [symbol] ³ to be the coordinates of the center of the volume, b can be computed according to the formula b=c+d−Ac, which guarantees Ac+b=c+d. That is, the center of the image is displaced by d units.

The output image can be defined by I_{affine}(x)=Iᵢₙ(Ax+b), where Iᵢₙ: [symbol] ³→ [symbol] denotes the input image volume from the training set. The discreet image data can be sampled from texture memory using trilinear interpolation, whereas the labels can be sampled according to the nearest neighbor voxel.

### Occlusion

Neural networks are often made more robust when forced to make predictions from only a portion of the available input. An efficient way to set up this scenario is to set part of the image volume to zero. In order to ensure that every voxel has an equal chance of being occluded, occlusion can be performed using a rectangular prism formed by the intersection of two half-spaces within the image volume. The prime height can be drawn uniformly as δ ϵ [0,δₘₐₓ] and starting coordinate z ϵ [−δₘₐₓn_{z}+δₘₐₓ], where n_{z} is the number of voxels in the z-dimension of the image. Then, the occluded image I_{occ} can be calculated as

$${I}_{occ} ( x ) = \{ \begin{matrix}0 , & z \geq {x}_{3} \geq δ \\ {I}_{affine} ( x ) , & \text{otherwise}\end{matrix} .$$

Since an affine transformation is already being applied to the image, removing an axis-aligned prism from the output effectively removes a randomly-oriented prism from the input. For efficiency, occlusion can be evaluated prior to sampling the image texture. If the value is negative, all future operations can be skipped, including the texture fetch.

### Noise

Additive Gaussian noise is a simplistic model of artifacts introduced in image acquisition. The operation is simply Iₙₒᵢₛₑ(x)=I_{occ}(x)+n(x), where n(x) is drawn from an independent, identically distributed Gaussian processed with zero mean and standard deviation σ. The sole parameter σ can be drawn from a uniform distribution for each training example. In this way, some images will be severely corrupted by noise, while others are hardly changed.

A GPU random number generator such as, but not limited to, cuRAND from the CUDA random number generation library by Nvidia can be used to quickly generate noise. In many embodiments, a separate random number generator (RNG) can be initialized for each GPU thread, with one thread per output voxel. To reduce instantiation overhead, each thread can use a copy of the same RNG, starting at a different seed. This sacrifices the guarantee of independence between RNGs, but is often not noticeable in practice.

### Intensity Windowing

In order to increase contrast, radiologists tend to view CT scans within a certain range of Hounsfield units. For examples, bones might be viewed with a window of −1000-1500 HU, while abdominal organs might be viewed with a narrower window of −150-230 HU. In order to train a model which is robust to a variety of window settings, a set of random limits a,b are drawn such that −∞<a<b<∞ according to user-specified ranges. Then,

$${I}_{window} ( x ) = min \{ max \{ \frac{{I}_{noise} ( x ) - a}{b - a} , 0 \} , 1 \}$$

can be computed. In order words, the intensity values are clamped to the range [a, b], and then affinely mapped to [0,1].

### Pipelined Memory Transfers

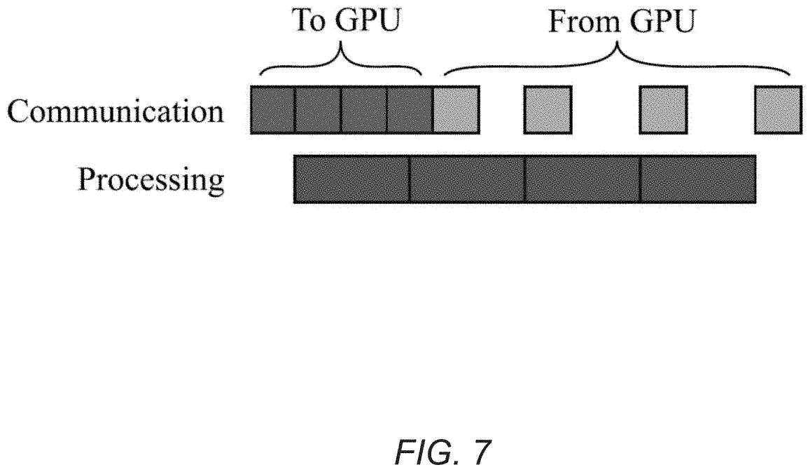

A common issue with heterogeneous computing is the cost of transferring data between memory systems, to mitigate this issue, a data augmentation system with a first-in first-out queue to pipeline jobs can be utilized. This concept is illustrated in accordance with an embodiment of the invention in FIG. 7. While one image is being processed, the next can have already begun transferring from main memory to graphics memory, effectively hiding its transfer latency. The FIFO programming model naturally matches the intended use case of augmenting an entire training batch at once.

Any or all of the above methodologies can be applied during augmentation of training data. Indeed, many of the above GPU accelerated methodologies can be applied in other data augmentation transformations without departing from the scope or spirit of the present invention. Augmented training data can be used to train a FCN, the architectures of which is discussed in further detail below.

### Neural Network Architectures

As noted above, FCNs can be utilized with any arbitrary imaging modality. However, given the number of modalities, CT scan inputs will be assume for explanatory purposes, as the model is better understood in a concrete context. One of ordinary skill in the art can appreciate that modifications to various parameters can be made in order to match the outputs of a given modality as appropriate to the requirements of specific applications of embodiments of the invention.

Prior to input, source medical images can be preprocessed to standardize inputs to the neural network. Similarly, in many embodiments, the output of the neural network is a probability map, and therefore is postprocessed to form visualizations that are easier for human comprehension. With respect to preprocessing, CT scans typically consist of hundreds of 512×512 slices of 12-bit data. In many embodiments, a neural network takes as an input a 120×120×160 image volume, and outputs a 120×120×160×6 probability map, where each voxel is assigned a class probability distribution. This becomes a 120×120×160 prediction map by taking the arg max probability for each voxel. However, should different input sizes be used, the size of the prediction map may be subject to change. In order to reduce memory requirements, all image volumes can be resampled to a standard size prior to input into the model. In numerous embodiments, the standard image volume size is 3 mm³, however alternative sizes can be utilized.

Resampling can be performed using Gaussian smoothing, which serves as a lowpass filter to avoid aliasing artifacts, followed by interpolation at the new resolution. In numerous embodiments, each CT scan has its own millimeter resolution for each dimension u=(u₁, u₂,u₃). To accommodate, the Gaussian smoothing kernel can be adjusted according to the formula

$$g ( x ) ∝ exp ( - {\sum }_{k = 1}^{3} \frac{{x}_{k}^{2}}{{σ}_{k}^{2}} )$$

where the smoothing factors are computed from the desired resolution r=3 according to σₖ=⅓max(r/uₖ−1,0). This heuristic formula is based on the fact that, in order to avoid aliasing, the cutoff frequency should be placed at r/uₖ, the ratio of sampling rates, on a [0,1] frequency scale.

On the postprocessing side of the model, the 120×120×160 prediction map can be resampled to the original image resolution using nearest neighbor interpolation. One challenge is that CT scans vary in resolution and number of slices, and in some embodiments, at 3 mm³ it is unlikely to fit the whole scan within the network. For training, this can be addressed this by selecting a 120×120×160 subregion from the scan uniformly at random. For inference, the scan can be covered by partially-overlapping sub-regions, and averaging predictions where overlap occurs. While in many situations, a single 3 mm³ network achieves competitive performance other volume sizes and sampling approaches can be utilized as appropriate to the requirements of specific applications of embodiments of the invention.

Turning now to the FCN architecture itself, in many embodiments, a neural network which balances speed and memory consumption with accuracy is utilized. The architecture described below is based on GoogLeNet, but with convolution and pooling operators working in 3D instead of 2D. The network consists of two main parts: decimation and interpolation. The decimation network is similar to convolutional neural networks (CNNs) used for image classifications, having three max-pooling layers each decimating the feature map by a factor of two in each dimension. The interpolation network performs the reverse operation, creating successively larger feature maps by convolution with learned interpolation filters. In numerous embodiments, no skip connections are utilized, which forward feature maps in the decimation party to later layers in the interpolation part. In contrast, in many embodiments, the interpolation part consists of only a single layer. By using a single layer, memory can be conserved which is at a premium due to handling 3D models.

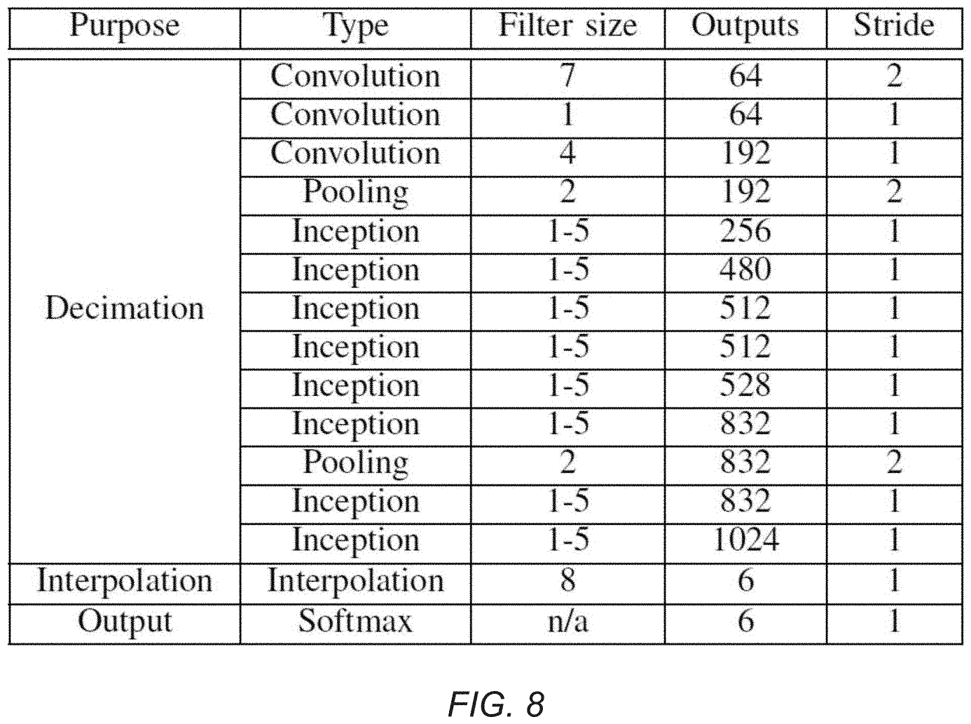

Turning now to FIG. 8, table listing layers in a neural network in order from the input image data to the final probability maps in accordance with an embodiment of the invention is illustrated. The specific details of each layer type should be familiar to one of ordinary skill in the art. In many embodiments, filter sizes and strides apply to all three dimensions. For example a filter size of 7 implies a 7×7×7 isotropic filter. All convolutions can be followed by constant “bias” addition, batch normalization and/or rectification. In the illustrated embodiment, pooling always refers to taking neighborhood maxima. An inception module consists of a multitude of convolution layers of sizes 1, 3 and 5, along with a pooling layer, which are concatenated to form four heterogeneous output paths. In numerous embodiments, the inception module is a memory-efficient way to construct very deep neural networks, since it features relatively inexpensive operations of heterogeneous sizes. For simplicity, the total number of outputs of the inception module can be reported rather than the number of filters of each type. The final softmax layer outputs class probabilities for each voxel.

While a specific architecture is discussed with respect to FIG. 8, one of ordinary skill in the art can appreciate that modifications to the layer and/or addition/removal of layers can be done without departing from the scope or spirit of the invention. Further, as noted above, the FCN described utilizes a unique loss function referred to herein as CE-IOU loss. This loss function is discussed in more detail below.

### CE-IOU Loss Function

The CE-IOU loss function is a combination of the CE and IOU loss functions that combine their respective strengths. Namely, while the basic IOU loss function has good performance, the training speed is not always as high as could be desired. In contrast the CE loss function is not particularly well suited for medical image segmentation because it handles class imbalance poorly. However, the CE loss function confers fast training. A discussion of each individual function separately, and then their combination follows.

### Basic IOU Loss

The normal intersection-over-union (IOU) loss function is an extension of the binary IOU loss function. For sets A and B, the binary function is

$${f}_{IOU} = \frac{\vert A ⋂ B \vert}{\vert A ⋃ B \vert} ,$$

where |A∩B| is the number of elements in the intersection between A and B, and |A∩B| is the number of elements in their union. To develop a loss function for machine learning classification purposes, this function must operate on probabilities rather than sets. Thus, let A and B both be subsets of some finite sample space Ω={ω₁, ω₂, . . . , ωₙ}. Sets can be represented as binary probability vectors in the sample space by a probability vector p ϵ [0,1]ⁿ such that

$${p}_{k} ( A ) = \{ \begin{matrix}1 , & {ω}_{k} ∈ A \\ 0 , & {ω}_{k} ∉ A\end{matrix}$$

For the basic IOU loss function, let y ϵ {0,1}ⁿ denote the binary vector encoding the ground truth segmentation of an image. For example, in organ segmentation, yₖ=1 if voxel k is part of the organ, and yₖ=0 otherwise. Next, let p ϵ [0,1]ⁿ denote the probabilistic prediction of a classification model. For example, in organ segmentation, pₖ ϵ [0,1] is the predicted probability of voxel k belonging to the organ. Then the IOU loss is defined as

$${ℒ}_{IOU} ( p , y ) = \frac{{\sum }_{k = 1}^{n} {p}_{k} {y}_{k}}{{\sum }_{k = 1}^{n} ( {p}_{k} + {y}_{k} - {p}_{k} {y}_{k} )}$$

[symbol]

_{IOU}(p,y) corresponds to the set function ƒ_{IOU} in the case that p ϵ {0,1}ⁿ, that is, p is a vector of binary probabilities which can be converted back into a set.

In many embodiments, a more general form for IOU losses is

$${ℒ}_{IOU}^{f} = \frac{{\sum }_{k = 1}^{n} {f}_{k} ( {p}_{k} ) {y}_{k}}{{\sum }_{k = 1}^{n} {f}_{k} ( {p}_{k} ) + {\sum }_{k = 1}^{n} {y}_{k} - {\sum }_{k = 1}^{n} {f}_{k} ( {p}_{k} ) {y}_{k}} = \frac{{\sum }_{\{ k : {y}_{k} = 1} {f}_{k} ( {p}_{k} )}{\vert \{ k \text{:} {y}_{k} = 1 \} \vert + {\sum }_{\{ k : {y}_{k} = 0} {f}_{k} ( {p}_{k} )}$$

where ƒ={ƒ₁, . . . , ƒₙ} is a collection of smooth increasing functions on [0,1] with ƒₖ(0)=0, ƒₖ(1)=1. These functions have the following properties: 1) they are equal to the desired binary loss, either Dice or IOU, when p is binary; 2) they are strictly increasing in each pₖ when yₖ=1, and decreasing when yₖ=0; 3) they are maximized only when p=y, and minimized only when p=1−y; and 4) they are smooth functions if the loss is defined to be 1 at p=y=0, which is otherwise undefined. In numerous embodiments ƒₖ is the identify function for each k. However, other variants of ƒₖ can be used as appropriate to the requirements of specific applications of embodiments of the invention.

### Cross-Entropy Loss

CE loss, also known as multinomial logistic regression, or log loss, is defined as

$${ℒ}_{CE} ( p , y ) = \frac{1}{n} {\sum }_{k = 1}^{n} {𝓁}_{CE} ( {p}_{k} , {y}_{k} )$$

$$where$$

$${𝓁}_{CE} ( {p}_{k} , {y}_{k} ) = \{ \begin{matrix}log {p}_{k} , & {y}_{k} = 1 \\ log ( 1 - {p}_{k} ) , & {y}_{k} = 0\end{matrix}$$

is the CE loss for a single voxel, and [symbol] _{CE} is the average over all voxels. The reason for taking the log of the probabilities is that machine learning models typically compute these through a sigmoid function

$${p}_{k} = \frac{{e}^{{x}_{k}}}{{e}^{{x}_{k}} + 1}$$

where xₖ is a vector of logits computed by the model. In this formulation, [symbol] _{CE}(p, y) is a concave function of the vector x=[x₁, . . . , xₙ]. In optimization theory, a concave function can be efficiently maximized, although this proves to not always be the case in deep learning scenarios which tend to compute x by a nonlinear function.

As noted above, CE loss is not well suited for medical image segmentation as it handles class imbalance poorly. That is, if Σₖyₖ<<n then a very high score results from simply classifying every voxel as not belonging to the organ. In practice, this often leads to the model failing to train.

### CE-IOU Loss

Although IOU loss can be utilized in its basic form as a loss function for FCNs described herein, in many embodiments, the CE-IOU loss function can maintain sufficient model performance while training at a higher speed. Above, several properties of basic IOU were discussed. Namely, the basic IOU functions are equal to the desired binary loss, either Dice or IOU, when p is binary. For CE-IOU, this property is relaxed such that instead of defining a loss which is equal when pₖ=yₖ, a loss is defined like CE, i.e. it grows to infinity as pₖ→1−yₖ. To achieve this, define the log probabilities

$${\tilde{p}}_{k} = \{ \begin{matrix}{𝓁}_{CE} ( {p}_{k} , {y}_{k} ) + 1 , & {y}_{k} = 1 \\ - {𝓁}_{CE} ( 1 - {p}_{k} , {y}_{k} ) , & {y}_{k} = 0\end{matrix}$$

It is straightforward to see that [symbol] _{CE}(pₖ, 1) ϵ (−∞, 1] while [symbol] _{CE}(pₖ, 0) ϵ [0, ∞). Thus the log probabilities have the ground truth probabilities at extreme points of their range, while the possible errors extend to ±∞. These can then be inserted into the IOU loss as

$${L}_{CE - IOU} ( p , y ) = \frac{{\sum }_{k = 1}^{n} {\tilde{p}}_{k} {y}_{k }}{{\sum }_{k = 1}^{n} ( {\tilde{p}}_{k} + {y}_{k} - {\tilde{p}}_{k} {y}_{k} )}$$

This can be further simplified to

$${L}_{CE - IOU} ( p , y ) = \frac{1 + \frac{1}{\vert k \text{:} {y}_{k} = 1 \vert} {\sum }_{\vert k \text{:} {y}_{k} = 1 \vert}^{n} {𝓁}_{CE} ( {p}_{k} , {y}_{k} )}{1 + \frac{1}{\vert k \text{:} {y}_{k} = 1 \vert} {\sum }_{\vert k \text{:} {y}_{k} \neq 1 \vert}^{n} {𝓁}_{CE} ( {p}_{k} , {y}_{k} )}$$

In order to address the asymmetry in the weights of the numerator and denominator penalties, the formula can be modified to give both classes approximately equal weight using the following final formulation:

$${L}_{CE - IOU} ( p , y ) = \frac{1 + \frac{1}{\vert k \text{:} {y}_{k} = 1 \vert} {\sum }_{\vert k \text{:} {y}_{k} = 1 \vert}^{n} {𝓁}_{CE} ( {p}_{k} , {y}_{k} )}{1 + \frac{1}{\vert k \text{:} {y}_{k} \neq 1 \vert} {\sum }_{\vert k \text{:} {y}_{k} \neq 1 \vert}^{n} {𝓁}_{CE} ( {p}_{k} , {y}_{k} )}$$

While the above formula is defined for binary classification tasks, in practice it can be beneficial to be able to distinguish multiple tasks simultaneously, e.g. identifying multiple different organs. The CE-IOU loss function can be extended to handle multi-class classification. For m−1 classes, yₖ ϵ {1, . . . , m}, and pₖ ϵ [0,1]^{m} is a probability distribution over the m classes. To define multi-class loss, replace 1−pₖ with p_{k,y}_{ₖ}, the probability of the ground truth class at voxel k, so the log loss for class c becomes [symbol] _{c}(p_{k,c}, Yₖ)=log p_{k,c}Yₖ.

Finally, a separate loss can be computed for each class at the final loss is the average of all class-specific losses, as defined by the formula

$${ℒ}_{MC} ( p , y ) = \frac{1}{m} {\sum }_{c = 1}^{m} \frac{1 + \frac{1}{\vert k \text{:} {y}_{k} = 1 \vert} {\sum }_{\vert k \text{:} {y}_{k} = 1 \vert}^{n} {𝓁}_{c} ( {p}_{k} , {y}_{k} )}{1 + \frac{1}{\vert k \text{:} {y}_{k} \neq 1 \vert} {\sum }_{\vert k \text{:} {y}_{k} \neq 1 \vert}^{n} {𝓁}_{c} ( {p}_{k} , {y}_{k} )}$$

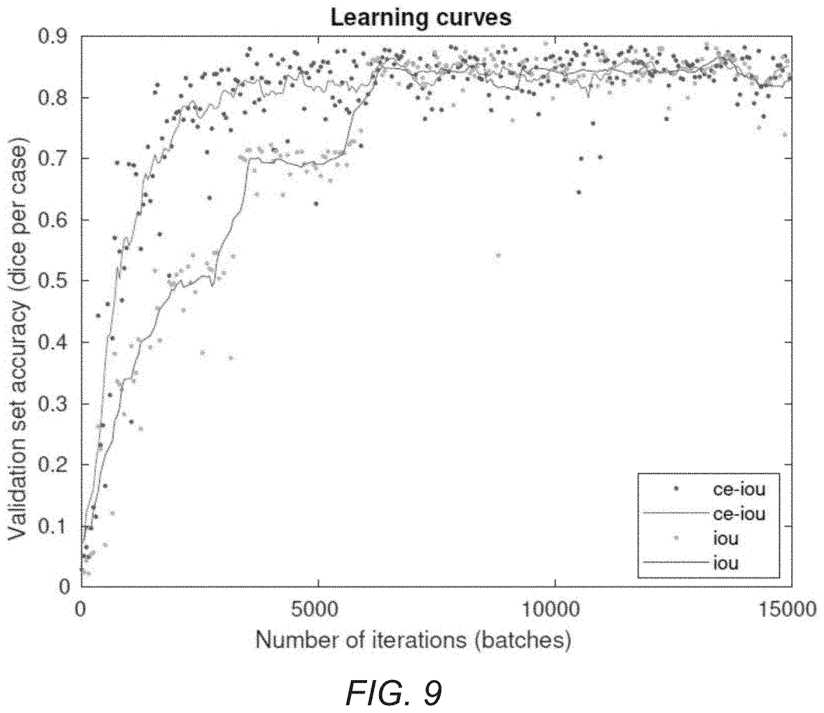

Turning now to FIG. 9, a chart reflecting a comparison of the basic IOU function and the CE-IOU functions using the same inputs in accordance with an embodiment of the invention. In the illustrated chart, each dot represents the average Dice score of the model's predictions modeled over 5 organ classes (excluding background), averaged again over 20 cases in an unseen test set. Lines represent the moving averages of the last 10 samples. In the test reflected in the illustrated chart, both losses were optimized using the RMS-prop method using the same hyperparameters, and training was begun from randomly initialized weights with no data augmentation. As can be seen, CE-IOU can train faster than IOU while achieving the same accuracy over the long term.

In numerous embodiments, the CE-IOU loss function and/or one of its variants are utilized in the loss layer of the FCN in order to accelerate training and maintain a high degree of functionality. However, any number of different loss functions can be utilized as appropriate to the requirements of specific applications of embodiments of the invention while maintaining the benefits of other enhancements described herein.

### Lesion Detection

The FCN described above can be used to effectively and efficiently segment organs in medical images, and the resulting segmented images can be used to detect lesions. In an example practical scenario, FDG-PET scans measure the rate of glucose metabolism at each location in the body, and are widely used to diagnose and track the progression of cancer. Cancer lesions often appear as “hotspots” of increased glucose metabolism. However, it is often difficult for computer algorithms to automatically differentiate between cancer hotspots and normal physiological uptakes. In order to disambiguate cancer from other sources of uptake, PET images are commonly acquired alongside low-dose, non-contrast CTs to form a PET-CT scan.

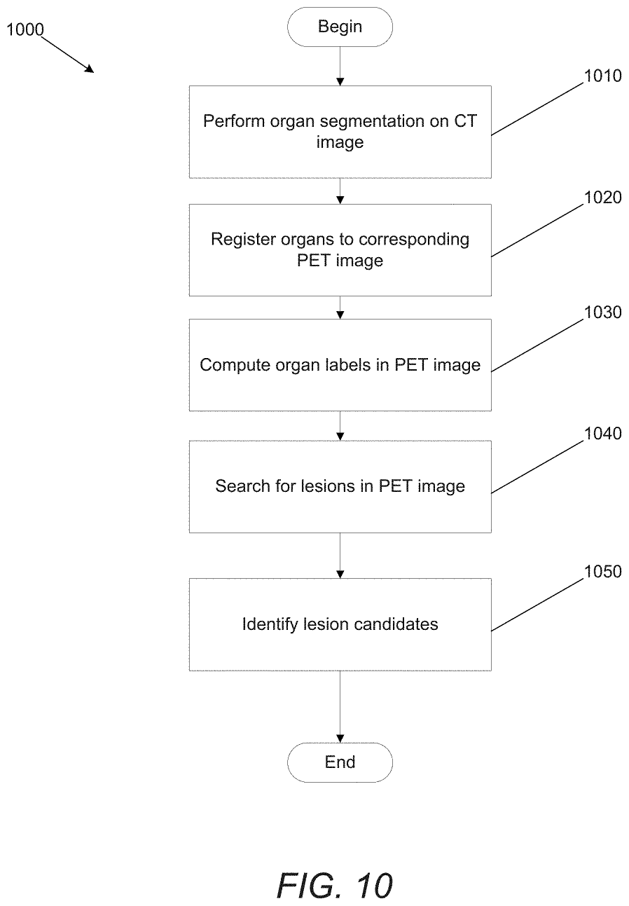

An exemplary process for identifying metastases in PET images in accordance with an embodiment of the invention is illustrated in FIG. 10. Process 1000 performing (1010) organ segmentation on the CT portion of the scan. Using processes described above, organs within the can be identified. The identified organs in the CT image are registered (1020) to the corresponding PET scan image according to the linear transform

$${x}_{CT} = ( \begin{matrix}{u}_{1} , CT / {u}_{1} , PET & 0 & 0 \\ 0 & {u}_{2} , CT / {u}_{2} , PET & 0 \\ 0 & 0 & {u}_{3} , CT / {u}_{3} , PET\end{matrix} ) {x}_{PET} ,$$

where u_{CT} and u_{PET} are 3-vectors encoding the resolution of each scan alon each of the three axes. The PET organ labels are then computed (1030) by nearest-neighbor interpolation using L_{PET}(x_{PET})=L_{CT}(x_{CT}).

A search (1040) for lesions in the PET image can then be conducted. In many embodiments, organ segmentation enables removal of tissues that are known to contain normal physiological uptake, such as, but not limited to, the kidneys and bladder. In various embodiments, a lesion detector based on small-space blob detection is utilized for the search. In many embodiments, operations in the small-space blob detection are defined on a restricted domain comprising the organ of interest.

For example, let S ⊂ [symbol] ³ denote the subset of PET image voxels corresponding to the lung. To motivate the restricted filter, consider a 1D convolution

ƒ×k(x)=∫_{-∞}^{∞}ƒ(s)k(x−s)ds

To restrict this to the organ S, define the indicator functions

$${X}_{k} ( x ) = f ( x ) = \{ \begin{matrix}0 , & k ( x ) = 0 \\ 1 , & k ( x ) \neq 0\end{matrix} and \\ {X}_{s} ( x ) = f ( x ) = \{ \begin{matrix}0 , & x ∉ S \\ 1 , & z ∈ S\end{matrix}$$

While this formulation is easy to compute, it can yield boundary effects when k(s−x) does not completely overlap with the organ outline Xₛ. To compensate for the boundary effects, each output can be divided by the amount of overlap between Xₛ and k(s−x). For a discreet filter with n+1 taps, this can be written as

$$g ( x ) = \frac{{\sum }_{s = 0}^{n} f ( x - s ) k ( s )}{{\sum }_{s = 0}^{n} {X}_{s} ( x - s )}$$

A key aspect of this formulation is that this can be expressed as a ratio of convolutions, of the form

$$\frac{{\int }_{- ∞}^{∞} {X}_{s} ( s ) f ( s ) k ( x - s ) ds}{{\int }_{- ∞}^{∞} {X}_{s} ( s ) {X}_{k} ( x - s ) ds} = \frac{( {X}_{s} \cdot f ) * k}{{X}_{s} * {X}_{k}}$$

which is evaluated over the set S. This assumes that k(0)≠0 to prevent division by 0. The extension of these convolutions to 3D is immediate, for both k and f. Further, other normalization kernels are possible, by the general form

$${g}_{h} ( x ) = \frac{{\sum }_{s = 0}^{n} f ( x - s ) k ( s )}{{\sum }_{s = 0}^{n} h ( k ( s ) ) {X}_{s} ( x - s )}$$

or equivalently

$${g}_{k} ( x ) = \frac{( {X}_{s} \cdot f ) * k}{{X}_{s} * ( h ∘ k )}$$

For example, the first formulation has (h∘k)=Xₖ, buy it may be useful in many embodiments to use (h∘k)=|k|, the absolute value kernel. By Holder's inequality, the absolute value kernel gives the operator norm of k in L_{∞}.

In numerous embodiments, the division has the intuitive property of compensating for the restriction of f to S, to avoid boundary effects when part of the filter kernel lies outside of S. This ratio of convolutions is a linear, but not shift-invariant operator, unless S is shifted as well. In many embodiments, each of the constituent convolutions is accelerated by 3D Fourier transforms. This is done via the formula, valid for any g, h: [symbol] ³→

[symbol]

g×h(x)= [symbol] ⁻¹{ [symbol] {g}· [symbol] {h}}

where

[symbol] {g}(ξ)=∫_{-∞}^{∞}g(x)e^{-2πiξ·x}dx

and

[symbol]

⁻¹{G}(x)=∫_{-∞}^{∞}G(ξ)e^{-2πiξ·x}dx

In this case, [symbol] is the Fourier transform and [symbol] ⁻¹ is the inverse Fourier transform. The discrete formulation is called the Discreet Fourier Transform, which is efficiently evaluated via a number of Fast Fourier Transform algorithms. In many embodiments, k×(ƒ·X_{S}) is computed by Fourier transforms as is Xₖ×X_{S}, which can save greatly on computation over direct evaluation of the first general form (summation form) of gₕ(x) above. This can provide a significant benefit over a more naïve approach which would compute the normalizing factor X_{S}×(h∘k) for each x without realizing that it can be written as a 3D convolution with the indicator function Xₛ.

A problem facing lesion detection is accuracy at the boundaries of organs. By Restricting the convolution to a specific organ, lesions proximal to organ boundaries can be detected without being influenced by tissue outside of the organ. With this framework, blobs of varying scale can be detected by considering the Gaussian kernel

G(x, σ) ∝ exp(−∥x∥₂²/σ²)

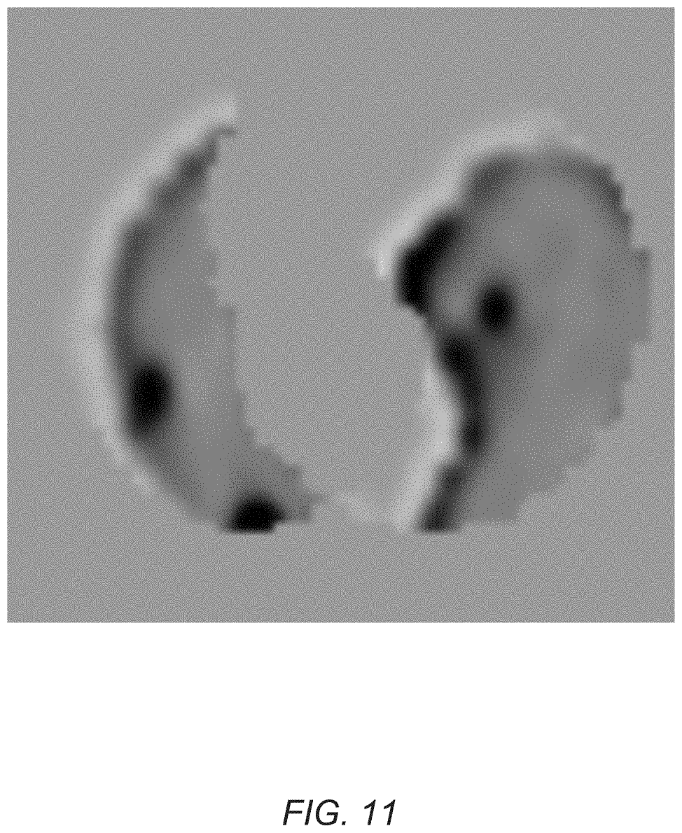

In many embodiments, the blob detector uses the Laplacian of the Gaussian filter

$$∇ G ( x ) = - \frac{2}{{σ}^{2}} G ( x ) ( n - \frac{2}{{σ}^{2}} {‖ x ‖}_{2}^{2} )$$

where n=3 is the dimension of the filter. Importantly, the convolution can be restricted to a specific organ by setting k=59 G, a formulation which allows the restricted convolution to be accelerated by Fourier transforms. This operation produces a 4D scale-space tensor defined by L(x, σ)=∇G_{σ}(x)×ƒ|_{S}(x), where σ is the scale, f is the original PET scan, and S is the organ of interest. Lesion candidates can be detected (1050), along with their scale, by detecting 3D local maxima in L. An example of identified cancer lesions, represented by dark areas, in accordance with an embodiment of the invention are illustrated in FIG. 11.

Although specific methods of segmenting images and detecting lesions are discussed above, many different methods can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for segmenting medical images, comprising:
obtaining a medical image of a patient, the medical image originating from a medical imaging device;
providing the medical image of the patient to a fully convolutional neural network (FCN), where the FCN comprises a loss layer, and where the loss layer utilizes the CE-IOU loss function;
segmenting the medical image such that at least one region of the medical image is classified as a particular biological structure; and
providing the medical image via a display device.

2. The method for segmenting medical images of claim 1, wherein the CE-IOU loss function is defined as
$${L}_{CE - IOU} ( p , y ) = \frac{1 + \frac{1}{\vert k \text{:} {y}_{k} = 1 \vert} {\sum }_{\vert k \text{:} {y}_{k} = 1 \vert}^{n} {𝓁}_{CE} ( {p}_{k} , {y}_{k} )}{1 + \frac{1}{\vert k \text{:} {y}_{k} \neq 1 \vert} {\sum }_{\vert k \text{:} {y}_{k} \neq 1 \vert}^{n} {𝓁}_{CE} ( {p}_{k} , {y}_{k} )}$$

3. The method for segmenting medical images of claim 1, wherein the CE-IOU loss function is capable of distinguish multiple tasks, and is defined as
$${ℒ}_{MC} ( p , y ) = \frac{1}{m} {\sum }_{c = 1}^{m} \frac{1 + \frac{1}{\vert k \text{:} {y}_{k} = 1 \vert} {\sum }_{\vert k \text{:} {y}_{k} = 1 \vert}^{n} {𝓁}_{c} ( {p}_{k} , {y}_{k} )}{1 + \frac{1}{\vert k \text{:} {y}_{k} \neq 1 \vert} {\sum }_{\vert k \text{:} {y}_{k} \neq 1 \vert}^{n} {𝓁}_{c} ( {p}_{k} , {y}_{k} )}$$

4. The method for segmenting medical images of claim 1, the FCN characterized by having been trained using training data, where the training data was augmented using a graphics processing unit (GPU) accelerated augmentation process comprising:
obtaining at least one base annotated medical image;
computing an affine coordinate map for the at least one base annotated medical image;
sampling the at least one base annotated medical image at at least one coordinate in the affine coordinate map;
applying at least one photometric transformation to generate an intensity value; and
outputting the intensity value to an augmented annotated medical image.

5. The method for segmenting medical images of claim 4, wherein the at least one photometric transformation is selected from the group consisting of: affine warping, occlusion, noise addition, and intensity windowing.

6. The method for segmenting medical images of claim 1, wherein the medical image of the patient comprises a CT image of the patient; and the method further comprising detecting lesions within segmented organs by:
obtaining a PET image of the patient, where the CT image and the PET image were obtained via a dual CT-PET scanner
registering the at least one classified region of the CT image to the PET image;
computing organ labels in the PET image;
searching for lesions in the PET image, wherein the search utilizes ratios of convolutions;
identifying lesion candidates by detecting 3D local maxima in a 4D scale-space tensor produced by the search; and
providing the lesion candidates via the display device.

7. The method of claim 6, wherein searching for lesions in the PET image is accelerated using fast Fourier transforms.

8. The method of claim 6, wherein the 4D scale-space tensor is defined by L(x, σ)=∇G_{σ}(x)×ƒ|_{S}(x).

9. The method of claim 1, wherein the display device is a smartphone.

10. The method of claim 1, wherein the medical image is a 3D volumetric image.

11. An image segmenter, comprising:
at least one processor; and
a memory in communication with the at least one processor, the memory containing an image segmentation application, where the image segmentation application directs the processor to:
obtain a medical image of a patient, the medical image originating from a medical imaging device;
provide the medical image of the patient to a fully convolutional neural network (FCN), where the FCN comprises a loss layer, and where the loss layer utilizes the CE-IOU loss function;
segment the medical image such that at least one region of the medical image is classified as a particular biological structure; and
provide the medical image via a display device.

12. The image segmenter of claim 11, wherein the CE-IOU loss function is defined as
$${L}_{CE - IOU} ( p , y ) = \frac{1 + \frac{1}{\vert k \text{:} {y}_{k} = 1 \vert} {\sum }_{\vert k \text{:} {y}_{k} = 1 \vert}^{n} {𝓁}_{CE} ( {p}_{k} , {y}_{k} )}{1 + \frac{1}{\vert k \text{:} {y}_{k} \neq 1 \vert} {\sum }_{\vert k \text{:} {y}_{k} \neq 1 \vert}^{n} {𝓁}_{CE} ( {p}_{k} , {y}_{k} )}$$

13. The image segmenter of claim 11, wherein the CE-IOU loss function is capable of distinguish multiple tasks, and is defined as
$${ℒ}_{MC} ( p , y ) = \frac{1}{m} {\sum }_{c = 1}^{m} \frac{1 + \frac{1}{\vert k \text{:} {y}_{k} = 1 \vert} {\sum }_{\vert k \text{:} {y}_{k} = 1 \vert}^{n} {𝓁}_{c} ( {p}_{k} , {y}_{k} )}{1 + \frac{1}{\vert k \text{:} {y}_{k} \neq 1 \vert} {\sum }_{\vert k \text{:} {y}_{k} \neq 1 \vert}^{n} {𝓁}_{c} ( {p}_{k} , {y}_{k} )}$$

14. The image segmenter of claim 11, wherein the FCN is characterizable by having been trained using training data, where the training data was augmented using a graphics processing unit (GPU) accelerated augmentation process comprising:
obtaining at least one base annotated medical image;
computing an affine coordinate map for the at least one base annotated medical image;
sampling the at least one base annotated medical image at at least one coordinate in the affine coordinate map;
applying at least one photometric transformation to generate an intensity value; and
outputting the intensity value to an augmented annotated medical image.

15. The image segmenter of claim 14, wherein the at least one photometric transformation is selected from the group consisting of: affine warping, occlusion, noise addition, and intensity windowing.

16. The image segmenter of claim 11, wherein the medical image of the patient comprises a CT image of the patient; and the image segmenting application further directs the processor to detect lesions within segmented organs by:
obtaining a PET image of the patient, where the CT image and the PET image were obtained via a dual CT-PET scanner;
registering the at least one classified region of the CT image to the PET image;
computing organ labels in the PET image;
searching for lesions in the PET image, wherein the search utilizes ratios of convolutions;
identifying lesion candidates by detecting 3D local maxima in a 4D scale-space tensor produced by the search; and
providing the lesion candidates via the display device.

17. The image segmenter of claim 16, wherein searching for lesions in the PET image is accelerated using fast Fourier transforms.

18. The image segmenter of claim 16, wherein the 4D scale-space tensor is defined by L(x, σ)=∇G_{σ}(x)×ƒ|_{S}(x).

19. The image segmenter of claim 11, wherein the display device is a smartphone.

20. The image segmenter of claim 11, wherein the medical image is a 3D volumetric image.
